(19) United States
(12) Patent Application Publication
(10) Pub. No.: US 2007/0290049 A1
(43) Pub. Date: Dec. 20, 2007

(54) Interactive transaction cards

(75) Inventor: William R. Ratcliffe, Thousand Oaks, CA (US)

Correspondence Address: KOPPEL, PATRICK & HEYBL, 555 ST. CHARLES DRIVE, SUITE 107, THOUSAND OAKS, CA, 91360, US

(73) Assignee: IntelCard, Inc.

(21) Appl. No.: 11/471,070

(22) Filed: Jun. 19, 2006

(51) Int. Cl. G06K 19/06

(52) U.S. Cl. 235/492

(57) ABSTRACT

Interactive transaction card structures and methods are disclosed which configure and arrange card elements (e.g., contacts, keypads, displays, memories, and microprocessors) to facilitate substantial expansion of the transactions available with conventional cards.

### BACKGROUND OF THE INVENTION

1. Field of the Invention

The present invention relates generally to transaction cards.

2. Description of the Related Art

Transaction cards facilitate the access of a variety of personal transaction functions for their owners. One of the original transaction cards is the ubiquitous magnetic stripe card which provides a modest amount of stored magnetic data (e.g., 140 bytes). This data is typically limited to the verification of information concerning the card's owner (e.g., name, account number). Although magnetic stripe transaction cards are inexpensive and widely used, their functions are severely limited. In addition, they can be easily duplicated and these duplicates then fraudulently used.

Memory cards replace the magnetic stripe with an electronic memory that holds significantly greater data storage (e.g., 1-4 kilobytes). This data can be read, altered and updated via a set of electrical contacts on the card which allow a card reader to access and power the card's memory. Memory cards have been used for various transactions such as pre-paid, disposable-card applications (e.g., phone cards). Memory cards are more expensive than magnetic stripe cards but their enhanced memory facilitates a greater range of transactions and provides greater security.

Microprocessor cards (sometimes called processor cards, chip cards or smart cards) insert a microprocessor between the electrical contacts and the memory of memory cards. In addition, they typically expand the memory size (e.g., to 8 kilobytes) and enhance the memory structure (e.g., to include read-only, random-access and programmable read-only memories). Similar to memory cards, processor cards are accessed and powered via a set of electrical contacts on the card. In contrast to memory cards, they are not totally dependent on the card reader (also known as the card-accepting device) for data processing.

Although presently-available transaction cards have expanded an original range of available transaction functions, they have generally failed to keep up with the ever expanding needs of card owners.

### BRIEF SUMMARY OF THE INVENTION

Interactive transaction card embodiments of the present invention offer an enhanced range of transaction functions to card owners. The drawings and the following description provide an enabling disclosure and the appended claims particularly point out and distinctly claim disclosed subject matter and equivalents thereof.

### BRIEF DESCRIPTION OF THE DRAWINGS

FIG. 1A is a front view of a transaction card embodiment of the present invention;

FIGS. 1B and 1C are views respectively along the planes 1B-1B and 1C-1C in FIG. 1A;

FIG. 2 is an enlarged view of a microprocessor and a printed circuit in the transaction card of FIG. 1A;

FIGS. 3A and 3B show enlarged side and top views of different battery embodiments for use in the transaction card of FIG. 1A;

FIG. 4 is a block diagram that corresponds to system elements in the transaction card of FIG. 1A;

FIG. 5 is a front view of another transaction card embodiment;

FIG. 6 is a flow diagram that illustrates processes realized by the transaction card of FIG. 1A; and

FIG. 7 is a diagram of a transaction system that uses transaction card embodiments of the present invention.

### DETAILED DESCRIPTION OF THE INVENTION

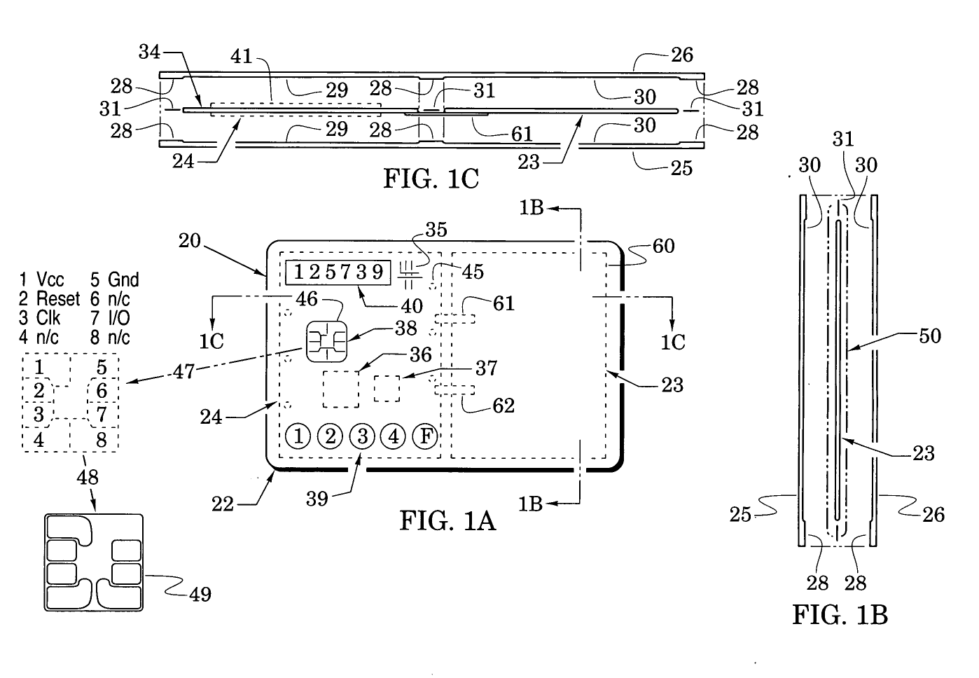

Interactive transaction card structure and method embodiments are shown in FIGS. 1A-7 which substantially expand the advantages and uses of conventional transaction cards. In particular, FIG. 1A illustrates a transaction card embodiment 20 which includes a card shell 22, a battery 23 embedded in a recess of the card shell, and a data exchange system 24 embedded in another recess of the card shell.

FIGS. 1B and 1C are views along the planes 1B-1B and 1C-1C of FIG. 1A and these views show that the card shell 22 preferably comprises first and second shell panels 25 and 26 that each define panel margins 28 and first and second panel depressions 29 and 30 within the margins. The data exchange system 24 is received into the first depressions 29 and the battery 23 is received into the second depressions 30. Subsequently, the shell panels are joined to complete the card shell 22 about the data exchange system and battery.

In one card embodiment, the shell panels comprise a flexible polymer (e.g., a thermoplastic polymer) and are joined with the aid of a bonding agent 31 that is inserted between the opposing margins 28 of the first and second shell panels 25 and 26. The bonding agent is compatible with the polymer shells and responds to heat and/or pressure to permanently secure the shell panels in an abutting arrangement.

The shell, battery and data exchange system are all configured to have a flexibility sufficient for conventional card use. In addition, the card shell 22 is configured to be consistent with the dimensions specified for identity cards (e.g., 85.60×53.98 millimeters with a 0.76 millimeter thickness) in the standard ISO 7810 of the international organization for standardization.

The data exchange system 24 is carried on a flexible printed circuit 34 (that defines circuit paths 35) and further includes a microprocessor 36, a memory 37, electrical contacts 38, a keypad 39 and a display 40 (an exemplary broken-line enclosure 41 in FIG. 1C indicates the elements of the system that are carried on the printed circuit 34). As indicated in FIG. 1A, the printed circuit 34 defines circuit paths 35 and the battery, the microprocessor, the memory, the contacts, the keypad and the display are carried on the printed circuit and interconnected via the circuit paths. The printed circuit 34 is preferably secured to the card shell 22 with various processes (e.g., a heat process or an ultrasonic process which produces staking structures 45).

The card shell 22 defines a window 46 and the electrical contacts 38 are accessible via the window. The electrical contacts are preferably configured to be consistent with the contact dimensions and locations specified in international standard ISO 7816-2. As shown by the example arrow 47, contacts 1 and 5 are intended to carry a supply voltage V_{cc} and ground, contacts 2, 3 and 7 are intended to carry reset, clock and input/output signals and contacts 4, 6 and 8 are currently not connected (n/c) and are reserved for future signals. Another example arrow 48 indicates one pattern embodiment 49 in which the contacts may be formed.

In another transaction card embodiment, the card shell 22 can be replaced with a molded shell 50 shown in broken lines in FIG. 1B. an embodiment of the molded shell is an injection molding such as a reaction injection molding (RIM). An RIM shell embodiment 50 is formed with polyurethanes and these polyurethanes can be selected to provide a fairly rigid shell (in one shell embodiment) or a flexible shell (in another shell embodiment). The polyurethanes can also be selected to provide a substantially opaque shell or a somewhat transparent shell.

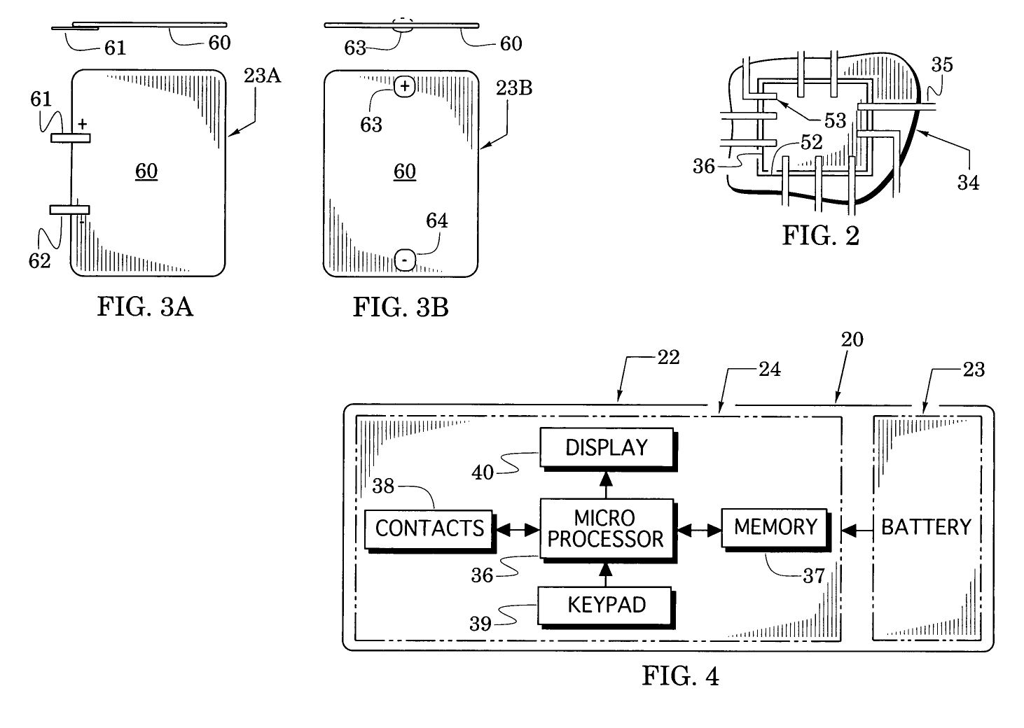

Attention is now directed to FIG. 2 which is an enlarged view of a portion of the printed circuit 34. This view shows that the printed circuit 34 preferably defines an aperture 52 which receives the microprocessor 36. A predetermined set 53 of the circuit paths 35 extend over the microprocessor and are operatively coupled to ports of the microprocessor. Although not shown, a fanout circuit pattern may be inserted between the microprocessor ports and the circuit paths.

The outer ends of the fanout are spaced significantly greater than the inner ends and this makes it easier to form attachments to the circuit paths 35. Preferably, the printed circuit 34 defines a second aperture and the memory (37 in FIG. 1A) is similarly received into the second aperture so that the printed circuit, the microprocessor and the memory are substantially coplanar and can thereby conform to the thickness limit (0.76 millimeter) of the transaction card.

As shown in FIGS. 1A-1C, the battery 23 is embedded in the card shell 22 to provide the supply voltage V_{cc} and the data exchange system 24 is embedded in the card shell to receive the supply voltage. Front and top views of one battery embodiment 23A are shown in FIG. 3A. In this embodiment, a flexible body 60 is covered by a foil sheet as are each of battery tabs (i.e., terminals) 61 and 62. As also shown in FIG. 1A, the terminals extend away from the battery body 60 to facilitate contact with the circuit paths (35 in FIG. 1A) of the flexible printed circuit (34 in FIG. 1B).

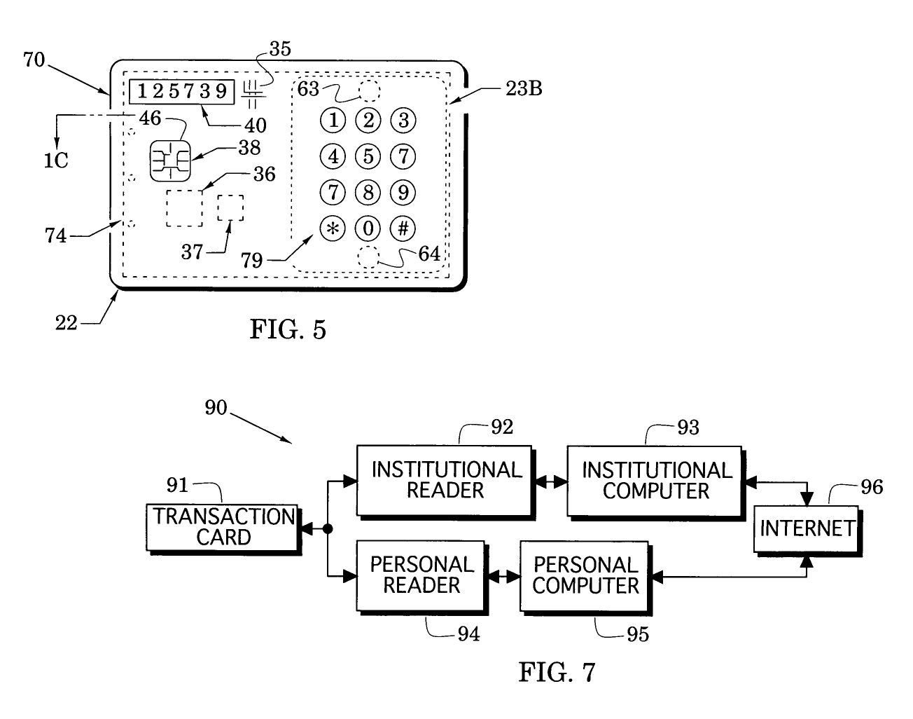

FIG. 3B shows another battery embodiment 23B in which the access to the battery is provided by contacts 63 and 64 that do not extend outward from the battery body 60 but, rather, are contained within the border of the battery. This embodiment is especially useful for a card embodiment such as that shown in FIG. 5. In another battery embodiment, one of the contacts can be moved to the other side of the battery as shown in broken lines in the top view of FIG. 3B.

One battery structural embodiment is a lithium polymer battery system having a manganese dioxide cathode and a metallic lithium anode which provides a nominal voltage of 3 volts and a nominal capacity of 40 milliamp/hours at 20 degrees Centigrade. This embodiment has a nominal thickness of 0.35 millimeters and includes a flexible aluminum foil jacket with anode and cathode tabs made of nickel flashed copper. This embodiment is especially suited for automated, high volume manufacturing.

In arrangement of the interactive transaction card 20 of FIG. 1A, the keypad 39 is coupled to the circuit paths 35 and is configured to receive tactile data and command instructions that may be inserted by a card owner, the display 40 is coupled to the paths to facilitate the display of visual data and commands, the contacts 38 are coupled to the circuit paths 35 to facilitate exchange of electrical data and commands, the microprocessor 36 is coupled to the circuit paths to process electrical data and commands, and the memory 37 is coupled to the circuit paths to store electrical data and commands that can then be accessed by the microprocessor.

To facilitate the entry of tactile data and commands by a card owner, the keypad 39 is formed with pressure-sensitive keys (e.g., domed switches, membrane switches). In the card embodiment of FIG. 1A, the keypad 39 comprises five pressure-sensitive keys and the microprocessor 36 is configured to recognize tactile pressure on one of the pressure-sensitive keys (marked F) as selection of a function and recognize tactile pressure on remaining pressure-sensitive entry keys (marked 1-4) as entered data.

In a display embodiment, the display 40 of FIG. 1A may be configured (e.g., with MicroSite technology) as a number (e.g., seven) of light-emitting diode (LED) segments that each draw approximately 0.1 milliamps of current. The microprocessor 36 is preferably configured to keep the display elements powered on for a predetermined time (e.g., 10 seconds). It is anticipated that when the transaction card 20 of FIG. 1A is not operated for an extended time, it will draw a small current (e.g., on the order of a few microamperes) to maintain the microprocessor in a “sleep” mode. If the card is operated three times a day, it is anticipated that the processor, display and PIN entry will consume a slightly greater current (e.g., on the order of a few milliamperes).

An operative system of the transaction card 20 is best seen in the block diagram of FIG. 4 which includes elements of FIG. 1A with like elements indicated by like reference numbers. As shown, the keypad 39 is provided to receive tactile data and commands and the display 40 is provided to display visual data and commands. The electrical contacts 38 facilitate exchange of electrical data and commands and the memory 37 stores electrical data and commands. Finally, the microprocessor 36 is coupled between the keypad, display, contacts, and memory to process tactile and electrical data and commands which are then displayed on the display, provided at the contacts, and/or stored in the memory.

The reduced keypad 39 is especially suited for transaction cards that are directed to uses in which the desired tactile entries are limited and/or are directed to a particular group of card owners. As an example, some events (e.g., the Special Olympics) are intended for participation of disabled persons and the keypad can be configured to facilitate their use of the transaction card. In an exemplary keypad configuration, the four entry keys in FIG. 1A could be altered to replace the numbers 1-4 with animal figures (e.g., wolf, bear, tiger and lion) and appropriate tactile entries might involve tactile pressure on one or more of these entry keys. The selection of appropriate ones of these figures may be easier considering the disabilities of the card owners.

Other transaction card embodiments may be directed to uses in which a more traditional keypad is suitable. FIG. 5, for example, illustrates a transaction card 70 which is similar to the transaction card 20 of FIG. 1A with like elements indicated by like reference numbers. In the card 70, however, the data exchange system (24 in FIG. 1A) has been extended to a data exchange system 74 which extends over most or all of the length of the card shell 22. A battery embodiment such as the battery 23B of FIG. 3B is positioned immediately behind the data exchange system 74 and has contacts 63 and 64 that abut and couple into circuit paths 35 in a flexible printed circuit of the data exchange system 74. The extended data exchange system 74 facilitates the use of an expanded keypad 79 which has additional keys.

In an exemplary transaction card interactive operation with the transaction card 20 and 70 of FIG. 1A, the function key F is pressed to activate the card. The microprocessor 36 may be programmed to respond by generating a message (e.g., “hello”) on the display 40 to indicate that the card system is on and that the card owner should input his or her personal identification number (PIN) via tactile pressure on the entry keys 1-4. The card system is configured to provide a short time (e.g., 10 seconds) for entry of each PIN digit.

When the PIN number has been entered, the system will, for a short time (e.g., 15 seconds), show a one-time use number in the display 40. This timeout can be extended for an additional time (e.g., 10 seconds) by pressing any of the numeric keys 39. The microprocessor 36 is programmed to randomly generate the one-time use number so that it is entirely unpredictable.

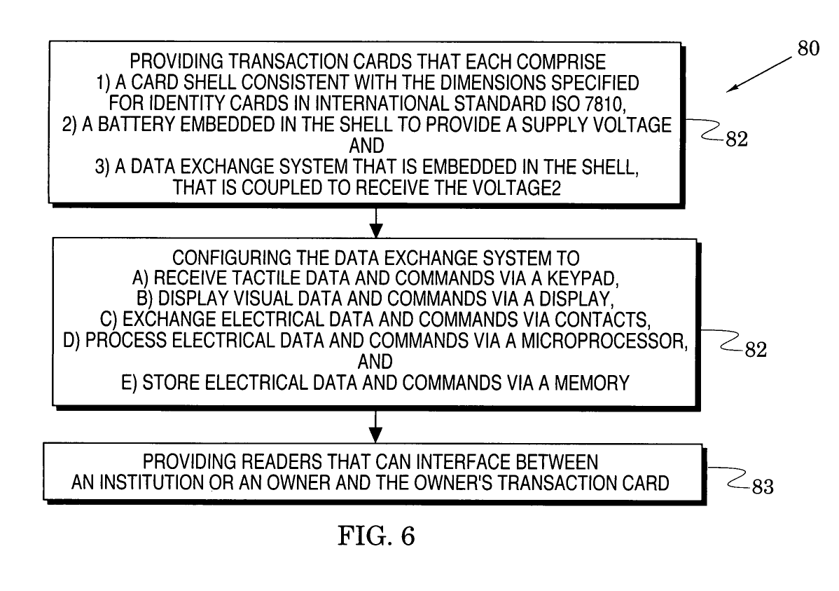

The interactive transaction card structure embodiments of FIGS. 1A-5 are suited for use in various interactive transaction methods such as that shown in the flow chart 80 of FIG. 6. In a process 81 of this method, transaction card are provided that each comprise:
1) a card shell consistent with the dimensions specified in international standard ISO 7816,
2) a battery embedded in the shell to provide a supply voltage, and
3) a data exchange system that is embedded in the shell.
   In a second process 82, the data exchange system is configured to:

A) receive tactile data and commands via a keypad,

B) display visual data and commands via a display,

C) exchange electrical data and commands via contacts,

D) process electrical data and commands via a microprocessor, and

E) store electrical data and commands via a memory.

### In a third process 83, card readers are provided that can interface between an institution (e.g., banks, restaurants, shops) or an owner and the owner's transaction card.

The interactive method embodiment 80 of FIG. 6 facilitates the interactive transaction card system 90 of FIG. 7 in which an owner's transaction card 91 can be accessed by institutional card readers 92 and by a personal card reader 94 which is located, for example, in an owner's residence and communicates with a personal computer 95. The institutional reader 92 can be used to conduct and complete transactions on an institutional computer 93 which can communicate with the personal computer via the internet 96.

Although the transaction cards 20 and 70 of FIGS. 1A and 5 are shown to have a standard ISO form of electrical contacts 38 to facilitate the data and command exchange in process step 82 of FIG. 6, other card embodiments may substitute other exchange structures such as:
a) microprocessor-emulated magnetic stripe transmission, and
b) electromagnetic transceivers utilizing wavelengths in transmission regions that include:
   a) the radio frequency (RF) region,
   b) the infrared (IR) region,
   c) the visual region, and
   d) the ultra violet (UV) region.

In an important feature of the invention, the personal card reader 94 can be used to initiate interactive transactions which are then completed via the card owner's personal computer 95 and the internet 96 which permits mutual data flow between the institutional computer and the personal computer. The transaction card embodiments of the invention and the system 90 of FIG. 7 facilitate a number of transactions of which a selected few are listed in the following transaction table.

TRANSACTION TABLE

authenticate card owner's identity
function for multiple applications
provide information concerning one or more of the
card owner's accounts with various entities
revise and store information in the card's memory
revise and store current account cash balances in the
card's memory
function as an “electronic purse”
facilitate banking, ticketing, ordering and purchasing
functions
facilitate passage through mass transit systems
interface with institutions via mobile telephones and
the internet
facilitate use of institutional services such as pay
telephones
function as phone cards, java cards, hotel coupons,
student cards
function as driving license, passport
facilitate healthcare, identification, electronic ticketing

The embodiments of the invention described herein are exemplary and numerous modifications, variations and rearrangements can be readily envisioned to achieve substantially equivalent results, all of which are intended to be embraced within the spirit and scope of the appended claims.

I claim:

1. A transaction card, comprising:
a card shell consistent with the dimensions specified for identity cards in international standard ISO 7810;
a battery embedded in said shell to provide a supply voltage; and
a data exchange system that is embedded in said shell, that is coupled to receive said voltage, and that is configured to receive tactile data and commands, display visual data and commands, and exchange, process and store electrical data and commands.

2. The card of claim 1, wherein said shell, said battery and said data exchange system are configured to have a flexible configuration.

3. The card of claim 2, wherein said shell is configured from a polymer.

4. The card of claim 1, wherein said data exchange system includes:
a flexible printed circuit that defines circuit paths;
a microprocessor carried within said printed circuit and coupled to said paths to process said electrical data and commands;
a memory carried within said printed circuit and coupled to said paths to store said electrical data and commands;
electrical contacts carried on said printed circuit, coupled to said paths and configured to be consistent with the dimensions and locations specified in international standard ISO 7816-2 to facilitate exchange of said electrical data and commands;
a keypad carried on said printed circuit and coupled to said paths to receive said tactile data and commands; and
a display carried on said printed circuit and coupled to said paths to facilitate said display of visual data and commands.

5. The card of claim 4, wherein said shell defines a window to expose said contacts.

6. The card of claim 4, wherein:
said printed circuit defines first and second apertures;
first and second predetermined sets of said circuit paths respectively extend over said first and second apertures; and
said microprocessor and said memory are respectively received within said first and second apertures and electrically coupled to said first and second sets.

7. The card of claim 6, wherein said printed circuit, said microprocessor and said memory are substantially coplanar.

8. The card of claim 4, wherein said keypad comprises five pressure-sensitive keys and said microprocessor is configured to recognize tactile pressure on one of said pressure-sensitive keys as selection of a function and recognize tactile pressure on remaining pressure-sensitive keys as entry of data.

9. The card of claim 8, wherein said pressure-sensitive keys are membrane switches.

10. The card of claim 4, wherein said shell is a reaction injection molding.

11. The card of claim 1, wherein:
said shell comprises first and second shell panels that each define margins and first and second depressions within said margins;
said data exchange system and said battery are respectively received within said first and second depressions; and
a bonding agent is inserted between the margins to secure said first and second shell panels in an abutting arrangement.

12. A transaction card, comprising:
a polymer card shell consistent with the dimensions specified for identity cards in international standard ISO 7810 wherein said shell defines a window;
a battery embedded in said shell to provide a supply voltage; and
a data exchange system that is embedded in said shell and includes:
a) a flexible printed circuit that defines circuit paths and first and second apertures;
b) electrical contacts carried on said printed circuit, coupled to said paths, positioned for access through said window, and configured to be consistent with the dimensions and locations specified in international standard ISO 7816-2 to facilitate exchange of electrical data and commands;
c) a keypad carried on said printed circuit and coupled to said paths to receive tactile data and commands;
d) a display carried on said printed circuit and coupled to said paths to facilitate display of visual data and commands;
e) a microprocessor carried within said printed circuit and coupled to said paths to process electrical data and commands; and
f) a memory carried within said printed circuit and coupled to said paths to store said electrical data and commands;
wherein first and second predetermined sets of said circuit paths respectively extend over said first and second apertures; and
said microprocessor and said memory are respectively received within said first and second apertures and electrically coupled to said first and second sets.

13. The card of claim 12, wherein said printed circuit, said microprocessor and said memory are substantially coplanar.

14. The card of claim 12, wherein said keypad comprises five pressure-sensitive keys and said microprocessor is configured to recognize tactile pressure on one of said pressure-sensitive keys as selection of a function and recognize tactile pressure on remaining pressure-sensitive keys as entry of data.

15. The card of claim 14, wherein said pressure-sensitive keys are membrane switches.

16. A method of conducting data transactions, comprising the steps of:
providing a card shell consistent with the dimensions specified for identity cards in international standard ISO 7810;
embedding a battery in said shell to provide a supply voltage; and
embedding, in said shell, a data exchange system that is coupled to receive said voltage, and that is configured to receive tactile data and commands, display visual data and commands, and exchange, process and store electrical data and commands.

17. The method of claim 16, wherein said providing step includes the step of configuring said data exchange system to include:
a printed circuit that defines circuit paths;
a microprocessor carried within said printed circuit and coupled to said paths to process said electrical data and commands;
a memory carried within said printed circuit and coupled to said paths to store said electrical data and commands;
electrical contacts carried on said printed circuit, coupled to said paths and configured to be consistent with the dimensions and locations specified in international standard ISO 7816-2 to facilitate exchange of said electrical data and commands;
a keypad carried on said printed circuit and coupled to said paths to receive said tactile data and commands; and
a display carried on said printed circuit and coupled to said paths to facilitate said display of visual data and commands.

18. The method of claim 16, further including the steps of:
exchanging electrical data and commands with said data exchange system; and
commanding said data exchange system to process and store electrical data and commands.

19. The method of claim 18, wherein said exchanging and commanding steps each include the steps of:
receiving electrical data and commands via said contacts; and
inserting electrical data and commands via said contacts.

20. The method of claim 19, further including the steps of:
providing, to an owner of one of said transaction cards, a personal reader that can interface between said owner and the owner's transaction card,
providing, to an institution, an institutional reader that can interface between said owner and the owner's transaction card; and
configuring said personal reader and said institutional reader for mutual communication via the internet.
